(19) United States
(12) Patent Application Publication
(10) Pub. No.: US 2007/0218094 A1
(43) Pub. Date: Sep. 20, 2007

(54) Method and Trap for Controlling Insect Pests

(75) Inventor: Alan James Julier, Cradley Nr. Malvern (GB)

Correspondence Address: Alan James Julier, Stirts House Bosbury Road, Cradley Nr. Malvern Worcestershire, WR13-5LT, GB

(73) Assignee: YE OLDE UPTON DELICATESSEN, Worcestershire (GB)

(21) Appl. No.: 11/628,540

(22) PCT Filed: Jun. 15, 2005
(86) PCT No.: PCT/GB05/02365

§ 371 Date: Dec. 4, 2006

(30) Foreign Application Priority Data
Jun. 23, 2004 (GB) 0414021.6

(51) Int. Cl. A01N 65/00; A01N 25/08

(52) U.S. Cl. 424/410; 424/734; 424/764; 424/745

(57) ABSTRACT

A method of controlling pests, such as crawling and flying insects by trapping and killing pests, comprising using organic particles, wherein the organic particles are of a composite of piperine, (C17 H19 N03), powders, the active principle of peppers, that adhere to the insects cupules and cleaving balls of pests, and an insect trap wherein the said organic particles are placed within.

### BACKGROUND OF INVENTION

The present invention relates to an environmental friendly way of destroying flying and crawling insects that are classed as pests Most common of these are house flies, horse flies, blow flies, mosquitoes, cockroaches, bugs and beetles and other crawling insects.

These pests are renowned for contaminating foods and spreading diseases in wild, domestic, agricultural animals, and birds, also of spreading diseases amongst human populations. Flies are also capable of transmitting bacterial pathogens such as Salmonella and Listeria to human and animals. There is various prior art relating to this subject for trapping insects, such as sticky bait stations, high voltage electrocutes, electrostatic powders, magnetic powders, powder paralysing powders, all have disadvantages that with the exception of the high voltage trap, they will not kill the insects, they are left to die over a long period of time A disadvantage of the high voltage trap, the insects tends to explode when electrocuted and splatter outside the trap and contaminate the area around the trap.

Other disadvantages of the above traps, some insects may crawl away and die together with associated contamination; the user of the trap has to kill the contents before they are disposed of.

There are other ways of killing insects by way of insecticide sprays, and aerosol sprays, these will eventually kill the insects but they fall and contaminate the area where they fall. And are hail to the environment for wildlife and humans. DDT is a good example,

### SUMMARY OF INVENTION

The present invention obviates the disadvantages in the above prior art comprises an apparatus, and an environmentally friendly powder, that is insoluble in water and not affected by humidity and ambient temperatures that demobilises insects and after a small period of time, the insects expire. It has been found by this invention that mill ground peppers partials also adhere to the cupules and cleaving balls of insects. The use of this demobilising powder adheres to the cupules and cleaving balls of the insect and they lose the ability to cling to a vertical or curved surface that is of a smooth and polished nature and will then fall into a catchment area of the designed apparatus. When the insect tastes the powder, its orientation is confused, the process of expiring becomes more rapid, and the insects lose the power of their legs and expire.

In carrying out the method of the present invention the insects are exposed to the powder particles which consists of a composition of piperine (C17 H19 N03), powders, preferably milled white pepper, other peppers could be used with similar effect. Also the berries of Cueba Clusii Miquel, The pepper powders which are used in the method of the present invention may consist solely of the pepper particles.

Another advantage of milled white pepper is that it adheres to smooth surfaces when disturb by insects, wind, or shaking and has the affect of creating a second chamber in the designed apparatus, this effect makes a return hazard to insects, if there is a remote possibility of the insects wanting to try and escape back from the direction of which they had fallen. Also the disabling powder will also arrive in the catchments area by the trapped insects. It must be noted that the trapped insects have expired by the use of the disabling powder and do not have to be dispatched when the trap is empted for re-use. In the case of some crawling insects it is of advantage to place a small amount of environmentally acceptable pesticide or insecticide in the catchments area of the trap, such as, extract of basil, marigold root, and ground coca leaves together with their particular bait attraction.

Another embodiment of the invention, the design apparatus and powder can be used inside a building environment, and outside of a building. And if situated in close proximity near an outside light would increase capture of night flying insects, for example mosquitoes.

Another embodiment of the invention the trap is found to be wild and domestic bird proof, when set outdoors, and could be constructed of non-magnetic materials, which would extend the life and cost of the trap, the materials used are recyclable, hygienic and environmentally acceptable, also washable and disposable.

### DRAWINGS OF INVENTION

FIG. 1. Shows the side elevation view of the top housing.

FIG. 2. Shows the plan view of the top housing, and section line A-A

FIG. 3. Shows the side elevation of the bottom housing.

FIG. 4. Shows the plan view of the bottom housing.

FIG. 5. Shows the side elevation of the disabling particle powder tray.

FIG. 6, Shows the plan view of the disabling particle powder tray.

FIG. 7. Shows the side elevation of the holding vessel lid.

FIG. 8 Shows the plan view of the holding vessel lid.

FIG. 9. Shows the side elevation of the holding vessel.

FIG. 10. Shows a cross-sectional view of the complete trap and secondary particle dusting area. Shown through A-A FIG. 2.

Before explaining the present invention in detail it is to be understood that the invention is not limited in its application to the details of construction and arrangements of parts illustrated in the accompanying drawings, since the invention is capable of other embodiments and of being practice or carried out in various ways. Also, it is to be understood that the phraseology or terminology employed is for purpose of description and not limitation.

The invention will now be further described with reference to the drawings.

The top housing body 1, of the insect trap, formed in the shape of a basin with a lip 2, the shape of 1, is not to be restricted by shape, size or known materials, preferably the material is opaque plastic. The inner surface 18 is of a smooth and polished finish so that insects having been exposed to the disabling particle powder 11, lose the ability to cling to the inner surface 18, and fall into the catchments area 16, the top housing body 1, has an insect entrance hole 3.

The bottom housing 4, has an inner smooth and polished surface 18, the shape of 4, is not restricted by shape, size or known materials, preferably opaque plastic, a pressed out hole 5, in the bottom, which is formed out into splines 6, the hole 5, is made slightly larger than the insect trapped, and acts as a chute for the insects that have contact with the disabling particle powder 11, the splines 6, also act as a non-return path for insects.

The top housing 1, and the bottom housing 4, which has a rim of slightly smaller diameter, fits into top housing 1, and the both housing are hinged 17, on the outside lip 2, by an adhesive connection, comprises a Velcro® strip for connection to a complementary Velcro® that has already been stuck to housing 1, 4. Detachable disabling particle powder tray 7, which has a much smaller diameter than bottom housing 4, fits inside bottom housing 4, and is made to fit 2 cm above the floor, of the bottom housing 4. This creates a second chamber 19, for the particle disabling powder 11. The number of secondary chambers and trays are not limited, preferably one.

Detachable disabling particle powder tray 7, has a pressed out hole 9, at its centre, which is formed out into splines 8, the hole 9, is made slightly larger than the insect to be trapped The detachable disabling particle powder tray 7, holds the disabling particle powder 11. The insects will alight or crawl onto the particle disabling powder 11, and when disabled fall through the hole 9, into a secondary chamber area 19, at the bottom, of the bottom housing 4.

Bottom housing 4, is fixed by its base onto holding vessel lid 12 by known means, which has a hole 15, at its centre, pressed out in the form of splines 14, is made slightly larger than the insect to be trapped and is fixed onto the holding vessel 10, which also has a smooth and polished inner surface 18, by known means, the lid 12, has the same size of hole as hole 5, 9, The lid 12 is affixed to the holding vessel 10, by known means, preferable by screw on, screw off action 13. Insects will finish up falling through hole 15, and into the catchments area 16. The holding vessel 10, perferably made of glass, so that un-trapped insects will have visual contact, this acts as a stimulant to flies, and crawling insects and will improve the trapping thereof.

Different bates 20, are placed into the catchments area 16, depending on what is attractive to the insects to be trapped, together with an appropriate pesticide or insecticide.

For flying insects, the ratio of the sizes of the top housing 1, bottom housing 4, and holding vessel 10, are 1.2-1.0.-1.0 respectively, but can be adapted, and are not restricted by these ratios. For crawling insects the ratios have to be modified, and insect crawling ramps with a rough surface will be needed, set up to touch the rim of top housing 1.

### Observation Experiment

The present invention involved a trial to determine the length of time, a common blowfly took to expire having made initial contact with the disabling particle powder.

A glass jar was given a light dusting of disabling particle powder. A blowfly was caught un-harmed and placed in the jar. When the blowfly came in contact with the disabling particle powder by walking across it, a timer was set and observations noted. After a few seconds, the blowfly could not cling to the sides of a vertical sided glass jar and started to launch itself into small flight jumps of a random nature. After 45 minutes the blowfly was on its back with its sensor rolling out. After another 15 minutes the blowfly expired. The present invention was left in an outside environment for one week, and was still trapping flying insects. The trap consisted of flies only and found all to have expired, and no bees had entered, so the trap proved to be environmentally acceptable.

1. A method of controlling pests, such as crawling and flying insects by trapping and killing pests, comprising using organic particles, wherein the organic particles are of a composite of piperine, (C17 H19 N03), powders, the active principle of peppers, that adhere to the insects cupules and cleaver ball of pests, and an insect trap wherein the said organic particles are placed within.

2. A method as claimed in claim 1 wherein the particles have an average particle size in the range of less than 50 micron −300 micron.

3. A method as claim 2 wherein the particles will disable and kill the insects.

4. A method as claim 3 wherein the particles are insoluble, and are not affected by humidity, and ambient temperatures, and are environmentally acceptable.

5. A method as claimed in one of the proceeding claims wherein the particles are applied to a surface in an area in which crawling and flying insects are present, preferably a slightly curved surface.

6. A crawling and flying insect trap comprising an upper and lower surface of smooth and polished nature, having an insect opening in the said upper surface leading to a holding vessel and catchment area in the said trap, also of smooth and polished nature, the upper surface and lower surface, interface into two halves, connected by a hinge.

7. An insect trap as claimed 6 which wholly uses, in its interior, detachable particle surface, organic material, compositition of piperine, ( C17 H19 N03), powders, extract of basil, marigold root, and ground coca leaves, baits attractive to the insects.

8. An insect trap as claim 7 wherein a detachable particle surface is placed in the interior.

9. An insect trap as claim 8 wherein a secondary particle area is in the interior.

10. An insect trap as claim 9 wherein a non return path for insects is in the interior.

11. An insect trap as claim 10 wherein the inner surfaces are made of smooth and polished materials, and are recyclable.

12. An insect trap as claim 11 which are wild and domestic bird proof.

13. An insect trap as claim 12 which is hygienic and washable, after disposal of insects.

14. An insect trap as claim 13 wherein the holding vessel is disposable.

15. An insect trap as claim 14 where the holding vessel is reusable.

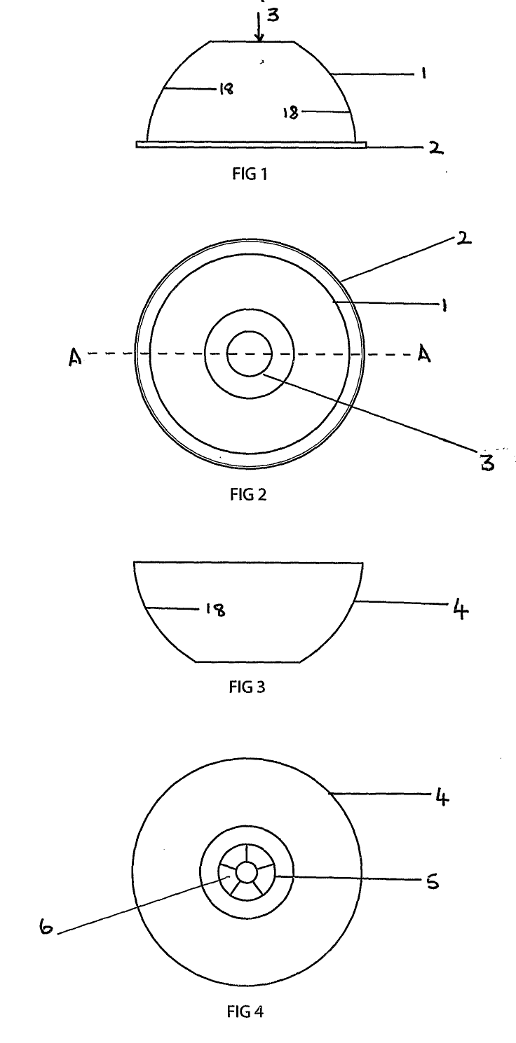

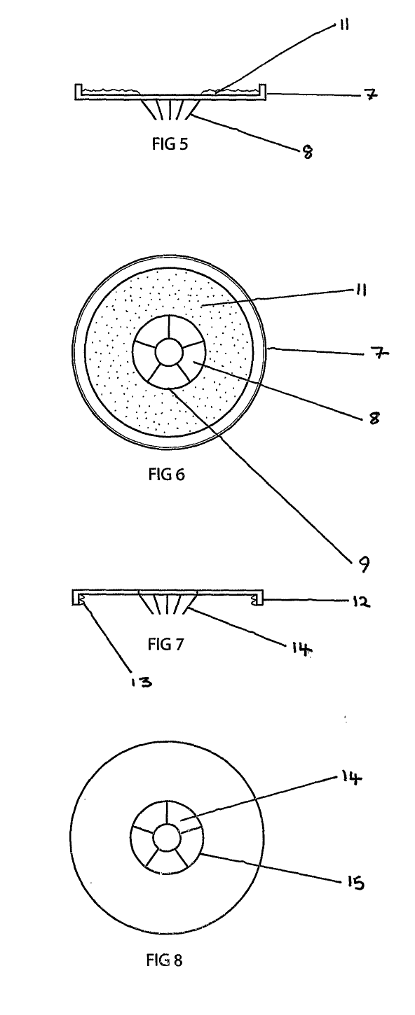

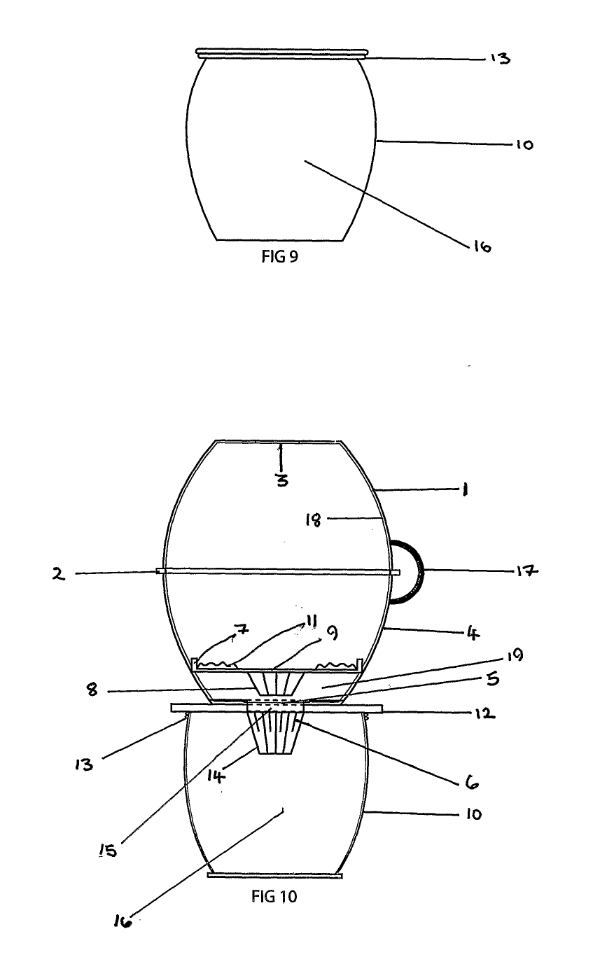

16. An insect traps claimed in claim 7 to 15, herein described substantially with reference to FIGS. 1 to 10 of the accompanying drawings.
